(19) United States
(12) Patent Application Publication
(10) Pub. No.: US 2018/0341871 A1
(43) Pub. Date: Nov. 29, 2018

(54) UTILIZING DEEP LEARNING WITH AN INFORMATION RETRIEVAL MECHANISM TO PROVIDE QUESTION ANSWERING IN RESTRICTED DOMAINS

(71) Applicant: Accenture Global Solutions Limited, Dublin (IE)

(72) Inventors: Anutosh MAITRA, Bangalore (IN); Shubhashis Sengupta, Bangalore (IN); Tom Geo Jain, Kerala (IN); Sanjay Podder, Thane (IN); Rajkumar Pujari, Andhra Pradesh (IN); Deepak Gupta, Varanasi (IN); Asif Ekbal, Bihta (IN); Pushpak Bhattacharyya, Bihta (IN)

(21) Appl. No.: 15/988,911

(22) Filed: May 24, 2018

(30) Foreign Application Priority Data
May 25, 2017 (IN) 201741018375

(51) Int. Cl. G06N 5/04; G06F 17/30; G06N 99/00; G06N 3/04

(52) U.S. Cl. CPC G06N 5/046; G06N 3/04; G06N 99/005; G06F 17/30654

(57) ABSTRACT

A device receives documents and previously answered questions associated with a restricted domain, and processes the documents and the previously answered questions to generate a corpus of searchable information. The device receives a question associated with the restricted domain, and processes the question, with a machine learning model or a rule-based classifier model, to determine a classification type for the question. The device manipulates the question to generate a query from the question, and processes the query, with an expansion technique, to generate an expanded query. The device utilizes the expanded query, with the corpus of searchable information, to identify candidate answers to the question, and processes the candidate answers and the classification type for the question, with a deep learning model, to generate scored and ranked candidate answers to the question. The device selects an answer from the scored and ranked candidate answers, and provides information indicating the answer.

### RELATED APPLICATION

This application claims priority under 35 U.S.C. § 119 to Indian Provisional Patent Application No. 201741018375, filed on May 25, 2017, the content of which is incorporated by reference herein in its entirety.

### BACKGROUND

Domain specific applications (e.g., interfaces to machine-readable technical manuals, front ends to knowledge sources, internal help desks, customer service desks, and/or the like) need to handle complex questions by combining domain specific information expressed in multiple structured, unstructured, and semi-structured sources using combinatorial extraction techniques. An answer seeker or a support provider often does not have enough time or resources to review a deluge of information in order to obtain a relevant and accurate answer. Business efficiency demands that the answer be available in a minimum amount of time.

### SUMMARY

According to some implementations, a device may include one or more memories, and one or more processors, communicatively coupled to the one or more memories, to receive documents and previously answered questions associated with a restricted domain, and process the documents and the previously answered questions to generate a corpus of searchable information. The one or more processors may receive a question associated with the restricted domain, and may process the question, with a machine learning model or a rule-based classifier model, to determine a classification type for the question. The one or more processors may manipulate the question to generate a query from the question, and may process the query, with an expansion technique, to generate an expanded query. The one or more processors may utilize the expanded query, with the corpus of searchable information, to identify candidate answers to the question, and may process the candidate answers and the classification type for the question, with a deep learning model, to generate scored and ranked candidate answers to the question. The one or more processors may select an answer to the question from the scored and ranked candidate answers, and may provide, for display, information indicating the answer.

According to some implementations, a non-transitory computer-readable medium may store instructions that include one or more instructions that, when executed by one or more processors, cause the one or more processors to generate a corpus of searchable information from documents and previously answered questions associated with a restricted domain, and receive a question associated with the restricted domain. The one or more instructions may cause the one or more processors to process the question, with a model, to determine a classification type for the question, and generate, based on the question, a query that is capable of being utilized with the corpus of searchable information. The one or more instructions may cause the one or more processors to process the query, with an expansion technique, to generate an expanded query, wherein the expanded query may include a greater retrieval performance than a retrieval performance of the query. The one or more instructions may cause the one or more processors to utilize the expanded query, with the corpus of searchable information, to identify candidate answers to the question, and process the candidate answers and the classification type for the question, with a deep learning model, to generate scores for the candidate answers to the question. The one or more instructions may cause the one or more processors to rank the candidate answers, based on the scores for the candidate answers, to generate ranked candidate answers, determine an answer to the question based on the ranked candidate answers, and provide, for display, information indicating the answer.

According to some implementations, a method may include receiving, from a user device, a question associated with a restricted domain, and processing the question, with a model, to determine a classification type for the question. The method may include generating, based on the question, a query that is capable of being utilized with a corpus of searchable information, and processing the query, with an expansion technique, to generate an expanded query. The method may include utilizing the expanded query, with the corpus of searchable information, to identify candidate answers to the question, and processing the candidate answers and the classification type for the question, with one or more deep learning models, to generate scores for the candidate answers to the question. The method may include ranking the candidate answers, based on the scores for the candidate answers, to generate ranked candidate answers, and selecting an answer to the question based on the ranked candidate answers. The method may include providing, to the user device, information indicating the answer to the question.

### BRIEF DESCRIPTION OF THE DRAWINGS

FIGS. 1A-1J are diagrams of an overview of an example implementation described herein.

FIG. 2 is a diagram of an example environment in which systems and/or methods, described herein, may be implemented.

FIG. 3 is a diagram of example components of one or more devices of FIG. 2.

FIG. 4 is a flow chart of an example process for utilizing deep learning to provide question answering for a restricted domain.

FIG. 5 is a flow chart of an example process for utilizing deep learning to provide question answering for a restricted domain.

FIG. 6 is a flow chart of an example process for utilizing deep learning to provide question answering for a restricted domain.

### DETAILED DESCRIPTION

The following detailed description of example implementations refers to the accompanying drawings. The same reference numbers in different drawings may identify the same or similar elements.

Question answering (QA) systems answer factual questions with short answers retrieved from a corpus based on vast general literature available in the public domain. Sometimes the QA systems extract the answers from a pre-specified information base containing a finite set of question-answer pairs. However, QA systems struggle to answer subjective questions with answers that include several well-formed sentences. This is primarily due to challenges in selecting appropriate answer text fragments from a document collection, generating answer text in such a way that sentences are coherent and cohesive, and ensuring syntactic and semantic well-formedness of the answer text.

QA systems in a restricted domain (e.g., software engineering) also face challenges like contextual appropriateness, semantically different terminology, and lack of adequate training data since most of the restricted domain corpus may be classified and not available for machine learning. A major challenge for restricted domain QA systems is obtaining proper linguistic support for extracting domain dependent information. For example, the restricted domain has to be circumscribed enough to build a comprehensive ontological resource for appropriate contextualization of questions. Deep and shallow information retrieval mechanisms often fail to detect relevant answer fragments in a given text. Moreover, established question processing mechanisms often fail to detect an actual intent of a question when asked in a specific domain.

Some implementations described herein utilize deep learning to provide question answering for a restricted domain. For example, a question answering platform may receive documents and previously answered questions associated with a restricted domain, and may process the documents and the previously answered questions to generate a corpus of searchable information. The question answering platform may receive a question associated with the restricted domain, and may process the question, with a machine learning model or a rule-based classifier model, to determine a classification type for the question. The question answering platform may manipulate the question to generate a query from the question, and may process the query, with an expansion technique, to generate an expanded query. The question answering platform may utilize the expanded query, with the corpus of searchable information, to identify candidate answers to the question, and may process the candidate answers and the classification type for the question, with a deep learning model, to generate scored and ranked candidate answers to the question. The question answering platform may select an answer to the question from the scored and ranked candidate answers, and may provide, for display, information indicating the answer.

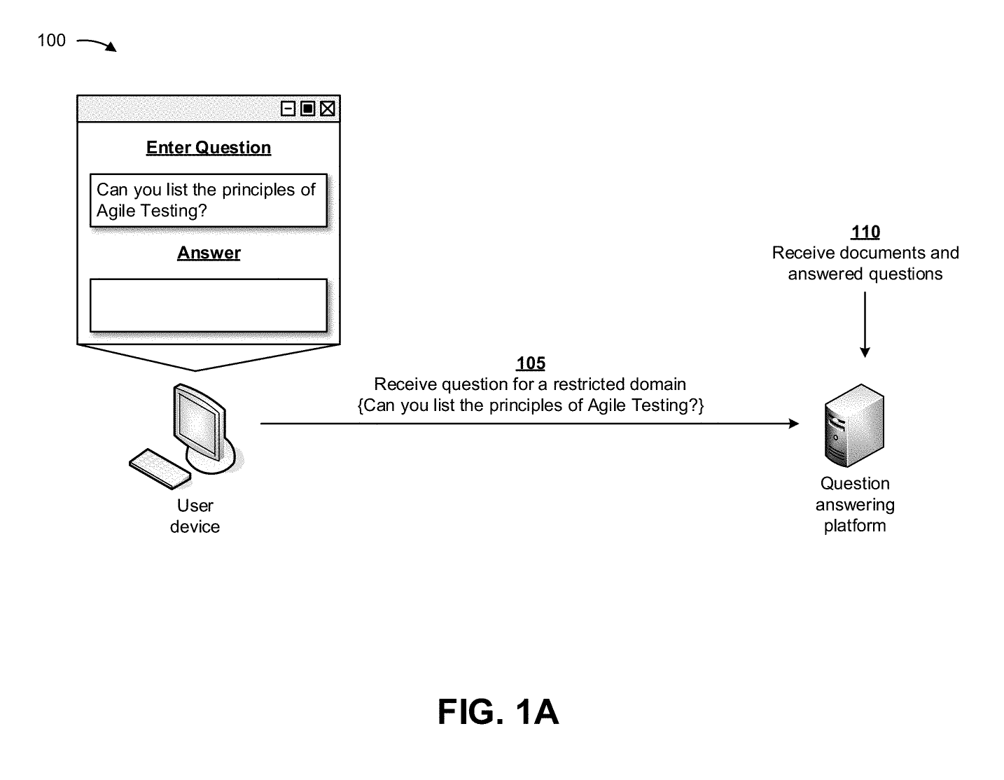

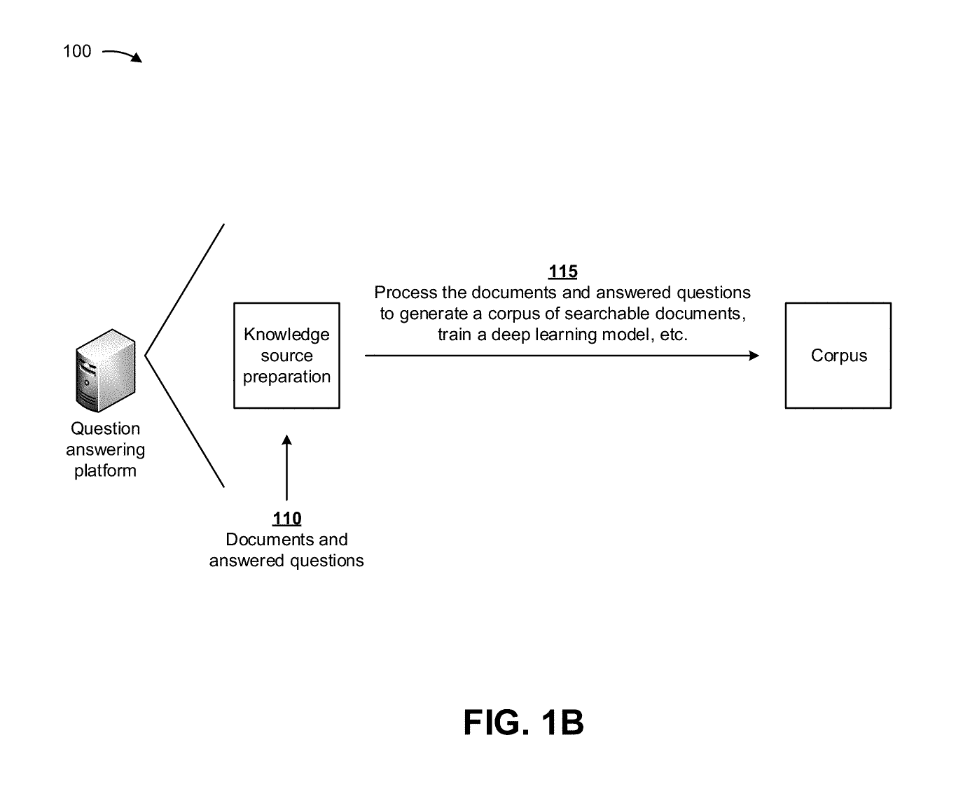

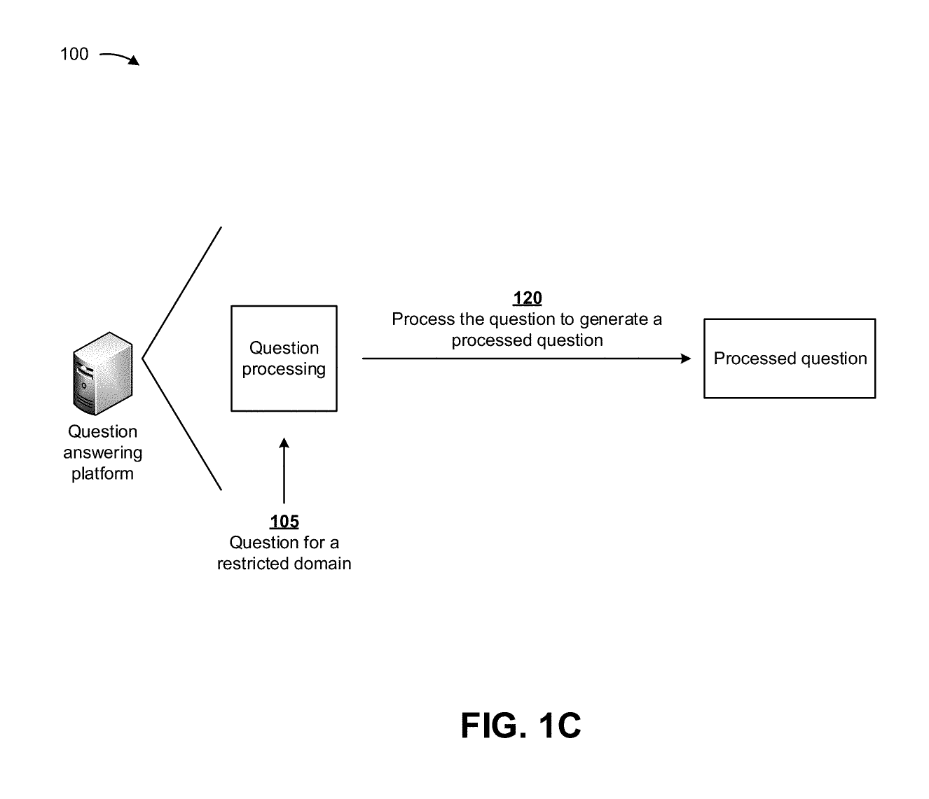

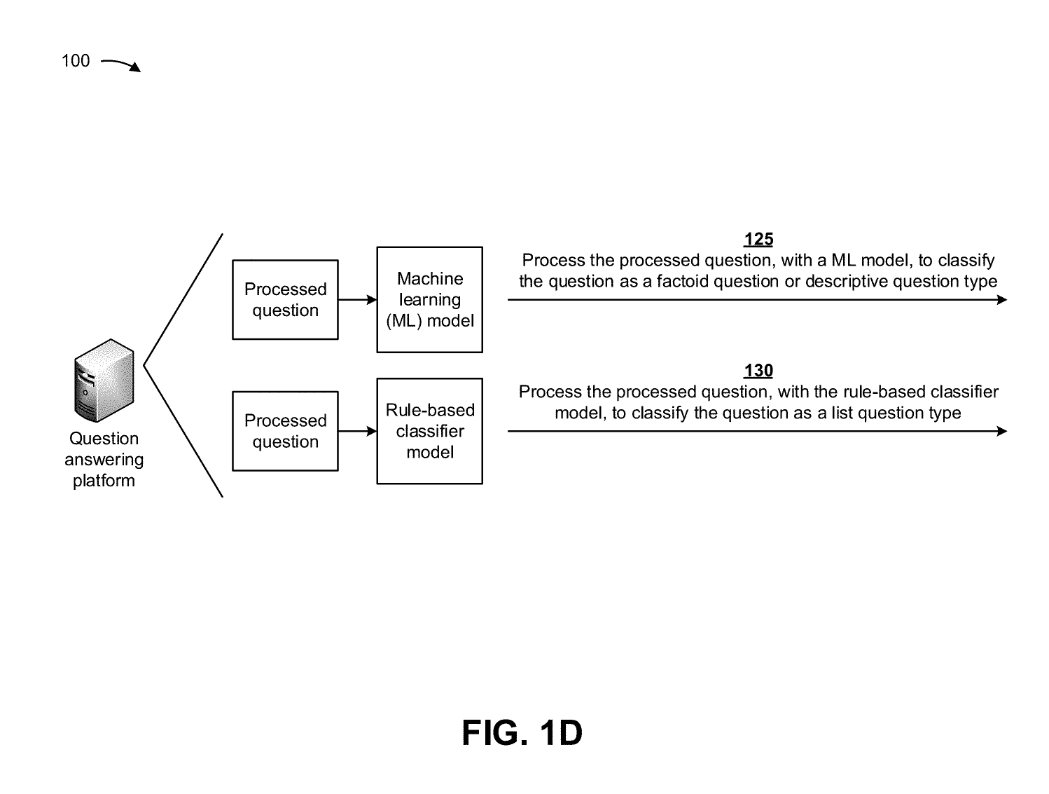

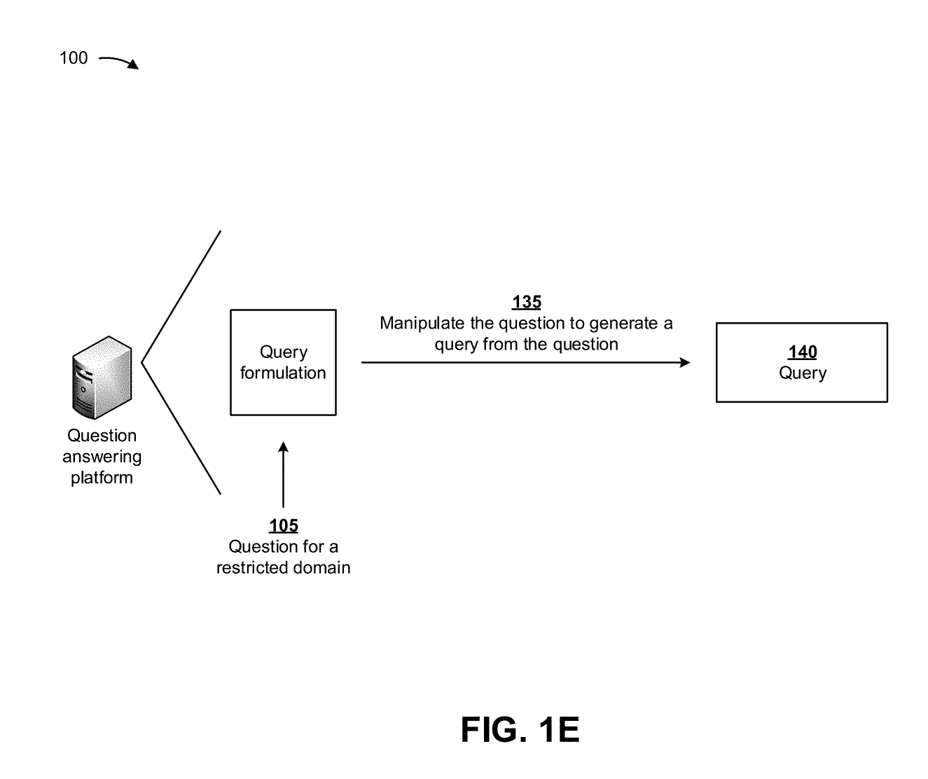

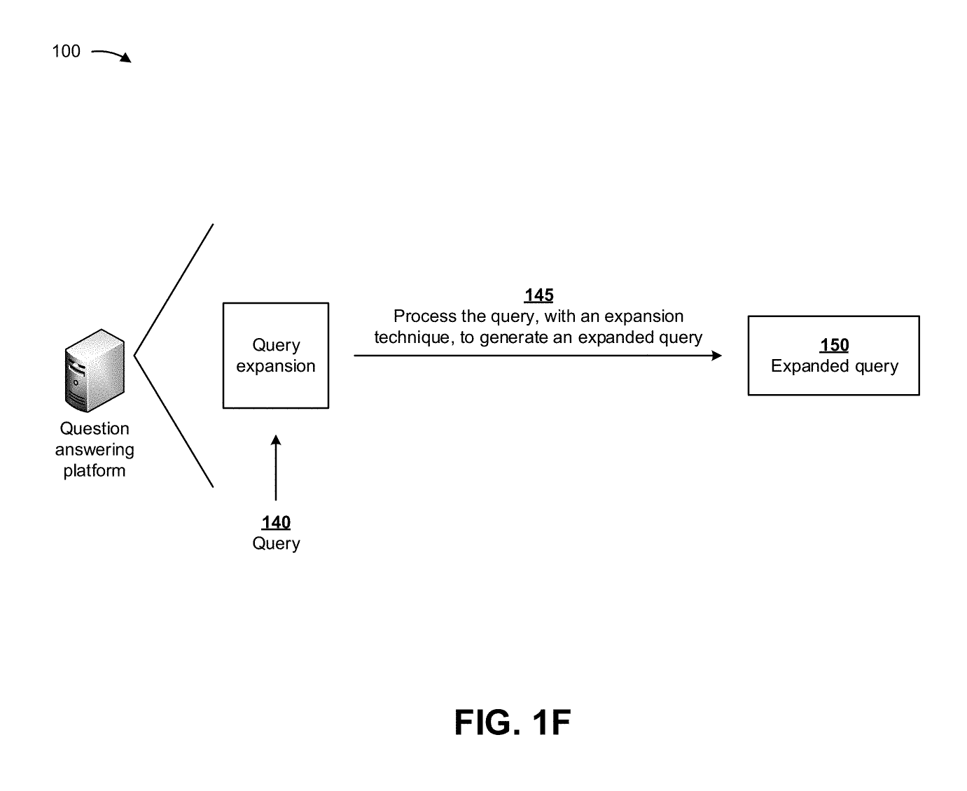

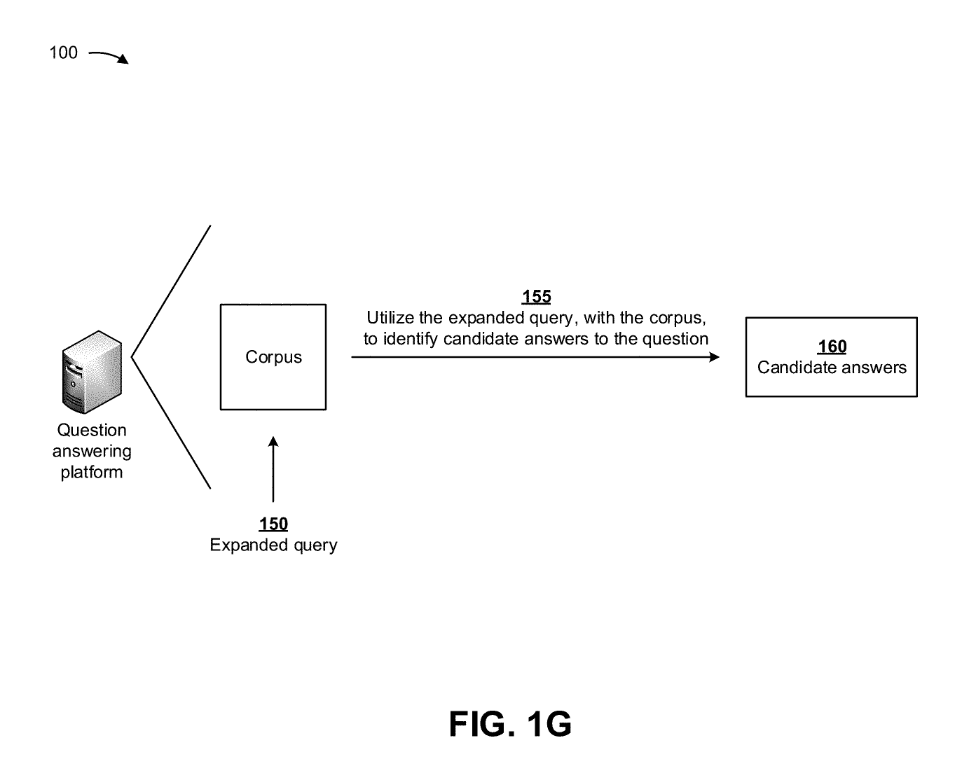

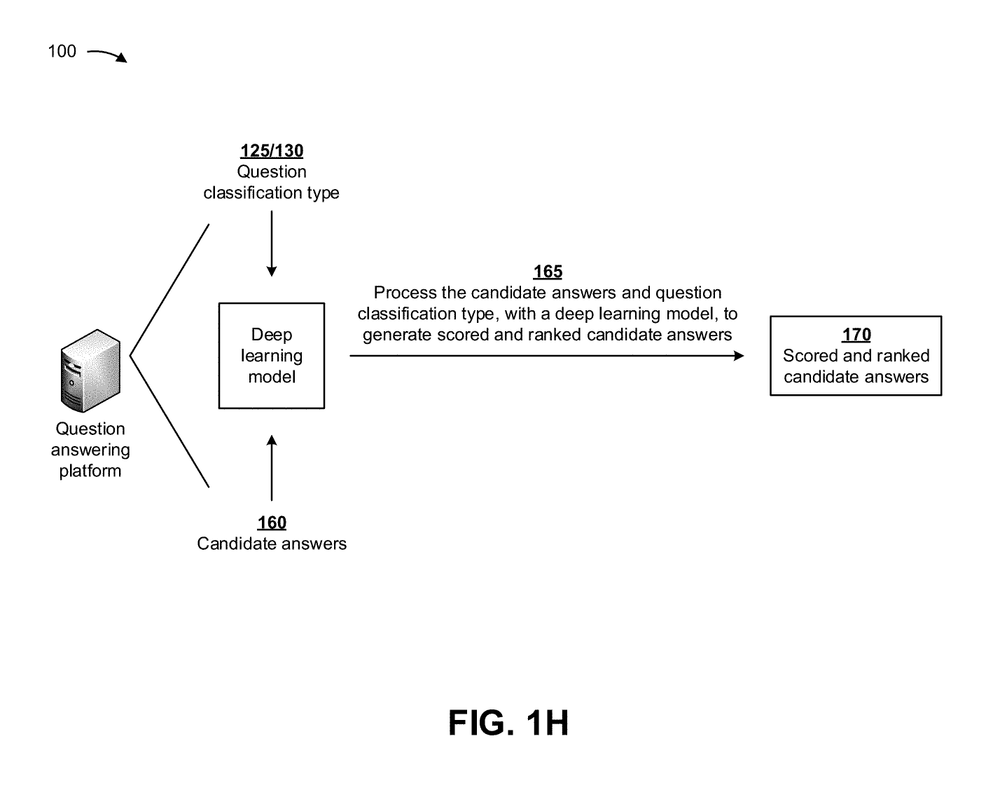

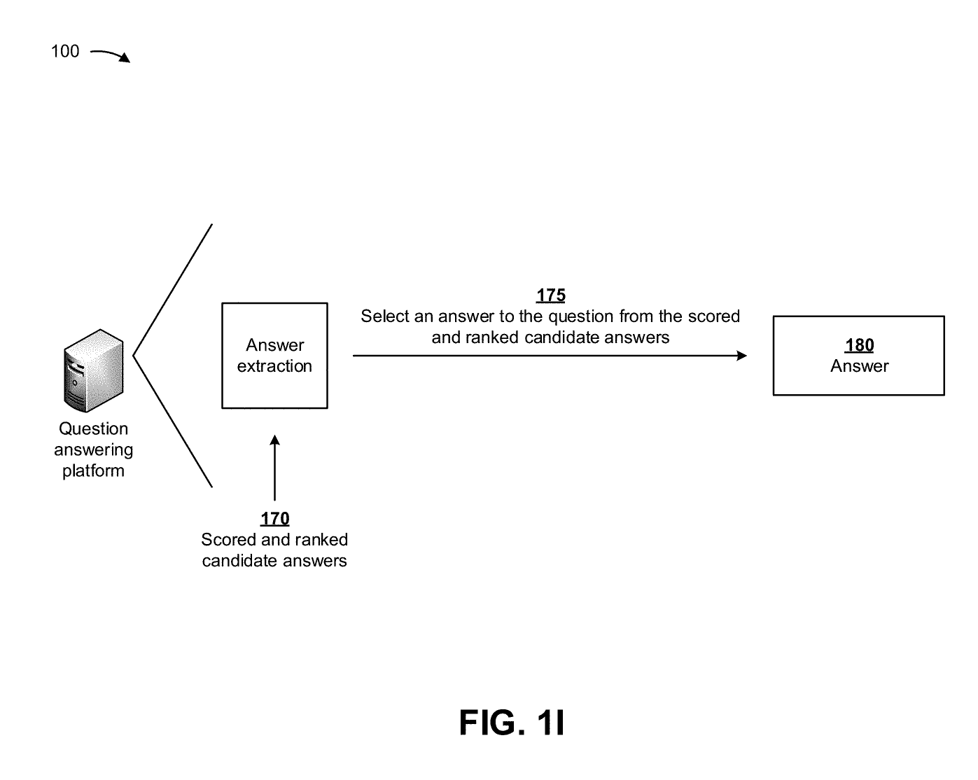

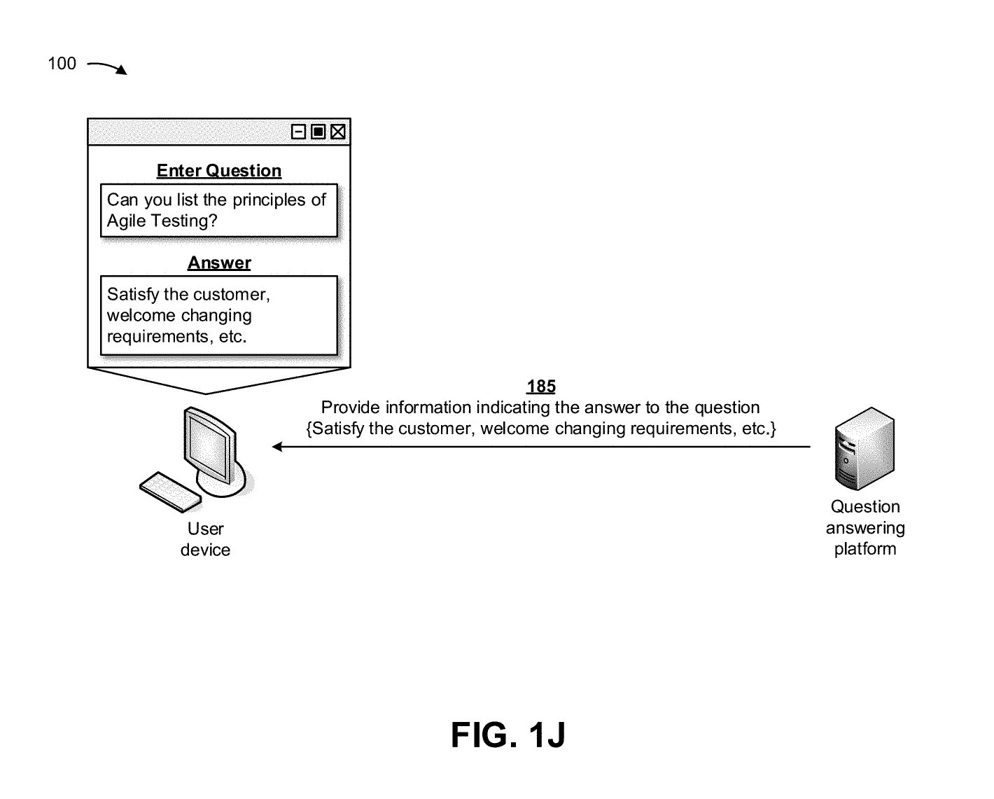

FIGS. 1A-1J are diagrams of an overview of an example implementation 100 described herein. As shown in FIG. 1A, a user device may be associated with a question answering platform. As shown in FIG. 1A, and by reference number 105, a user of the user device (e.g., via a user interface provided to the user) may cause the user device to provide, to the question answering platform, a question associated with a restricted domain. In some implementations, the restricted domain may include a domain with semantically different terminology, a domain that is classified and not available for machine learning, a domain that does not provide proper linguistic support for extracting domain dependent information, and/or the like. In some implementations, the question associated with the restricted domain may include a question associated with software engineering, such as “Can you list the principles of Agile Testing?”

As further shown in FIG. 1A, and by reference number 110, the question answering platform may receive, from one or more sources, documents and previously answered questions associated with the restricted domain. In some implementations, each document, of the documents, may include a text document with one or more text sections (e.g., paragraphs, sentences, and/or the like), such as plain text, annotated text (e.g., text with terms, tags associated with the terms, and/or the like), and/or the like. In some implementations, the documents may include documents received from an information source, such as Apache Lucene (e.g., a free and open-source information retrieval software library), and may be used to create a properly indexed and taxonomically indexed corpus of searchable information. In some implementations, the previously answered questions may include one or more questions and corresponding answers that were previously determined for the one or more questions. In some implementations, the documents and the previously answered questions may include general open domain documents and questions (e.g., with answers) from a general open domain.

In some implementations, the question answering platform may receive the question, the documents associated with the restricted domain, and the previously answered questions associated with the restricted domain, and may store the question, the documents, and/or the previously answered questions in a memory associated with the question answering platform.

In some implementations, the question answering platform may generate a semantically similar question based on the question and the documents. In some implementations, the question answering platform may identify semantically similar questions to the question received by the question answering platform. The semantically similar questions may include the same or almost similar answers in various lexical forms. Identifying already answered semantically similar questions may increase an accuracy of the question answering platform.

In some implementations, the question answering platform may include a question encoder model that is trained with a data set that includes semantically similar questions. The data set may include pairs of questions and matching or non-matching labels. The question encoder model may be utilized by the question answering platform to map a question body to a question vector representation. The question vector representation may be utilized by the question answering platform to compute similarity scores to other questions. In some implementations, the question encoder model may include neural encoder models, such as a gated recurrent unit (GRU) model, a recurrent convolutional neural network (RCNN) model, and/or the like.

In some implementations, the question answering platform may extract a focus of the question. The focus of the question may include a word or a sequence of words that defines the question and disambiguates the question (e.g., indicates what the question is looking for). The focus of the question may be contained within a noun phrase of the question, and the noun phrase may indicate what the question is expecting an answer to do. In the case of an imperative question, a direct object of a question word may contain the focus. In the case of an interrogatory question, there may be certain natural language dependencies that capture a relation between a question word and the focus.

In some implementations, the question answering platform may determine taxonomy features of the question. Questions may be ubiquitous in natural language. Some questions may be explicit, such as “where is Taj Mahal located,” and some questions may be implicit, such as “my keyboard is not working,” (e.g., which infers “can you repair my keyboard”). Some questions posted on question and answer websites may be long, multi-sentence text, and may not be necessarily well-formed. Some questions asked in a formal business setting may be syntactically well-formed and explicit.

In some implementations, the question answering platform may classify the question. The question answering platform may classify questions into decision questions and non-decision questions. Decision questions may include yes or no answers, while non-decision questions may require specific answers varying in length from possibly a single word to a few paragraphs. Decision questions may appear in different lexical constructs, such as “be” questions (e.g., is, are, was, were, and/or the like), “do” questions (e.g., do, does, did, and/or the like), modal questions (e.g., can, will, shall, and/or the like), has, have, had, or the like questions, and/or the like. Non-decision questions may be further classified into sub-categories, such as interrogatives (e.g., what, how, why, which, where, and/or the like), imperatives (e.g., describe, provide, justify, list, and/or the like), and/or the like. Further, each lexical construct can be sub-divided based on the answer types expected, such as time, person, location, descriptive, measure, and/or the like. A hierarchical structure in question taxonomy may then be evident.

In some implementations, the question answering platform may address the inadequacies in classifying a question when applied to a restricted domain. The inadequacies of classifying a question associated with restricted domain may occur since a distribution of class labels is different in restricted domains than in open domains, since word representations may be different in restricted domains than in open domains, and/or the like. As such, unlike the question answering platform described herein, current question classification techniques fail to provide adequate accuracy when applied to a restricted domain question set.

As shown in FIG. 1B, and by reference numbers 110, and 115, the question answering platform may process the documents and the previously answered questions to generate a corpus of searchable information (e.g., a more manageable corpus for answer searching) associated with the restricted domain, to train a deep learning model described below, and/or the like. In some implementations, the question answering platform may convert the documents and the previously answered questions into a searchable format. For example, the question answering platform may convert the documents and the previously answered questions from a particular format (e.g., a .doc extension file format) to a searchable format (e.g., an extensible markup language (XML) file format). In some implementations, the question answering platform may parse information in the documents and the previously answered questions so that the information may be more easily converted to the searchable format.

In some implementations, the question answering platform may utilize a natural language processing technique, a computational linguistics technique, a text analysis technique, and/or the like, with the documents and the previously answered questions, in order to make the documents and the previously answered questions analyzable. For example, the question answering platform may apply natural language processing (NLP) to interpret the documents and the previously answered questions and generate additional information associated with the potential meaning of information within the documents and the previously answered questions. Natural language processing involves techniques performed (e.g., by a computer system) to analyze, understand, and derive meaning from human language in a useful way. Rather than treating text like a mere sequence of symbols, natural language processing considers a hierarchical structure of language (e.g., several words can be treated as a phrase, several phrases can be treated as a sentence, and the words, phrases, and/or sentences convey ideas that can be interpreted). Natural language processing can be applied to analyze text, allowing machines to understand how humans speak, enabling real world applications such as automatic text summarization, sentiment analysis, topic extraction, named entity recognition, parts-of-speech tagging, relationship extraction, stemming, and/or the like.

In some implementations, the question answering platform may utilize a data normalization method to process the documents and the previously answered questions and to eliminate and/or reduce redundant information from the documents and the previously answered questions. The data normalization method may include identifying values or portions of data that are repeated unnecessarily in a file, data structure, and/or the like (e.g., in records or fields, within a table, and/or the like), eliminating such values or portions of data from the file, data structure, and/or the like, converting such values or portions of data from a differing and/or nonstandard format to a same and/or standard format, and/or the like. For example, the data normalization method may include database normalization, such as may be applied to a relational database to organize columns (attributes) and tables (relations) of a relational database to reduce data redundancy and improve data integrity. Database normalization may involve arranging attributes in relations based on dependencies between attributes, ensuring that the dependencies are properly enforced by database integrity constraints. Normalization may be accomplished by applying formal rules either by a process of synthesis (e.g., creating a normalized database design based on a known set of dependencies) or decomposition (e.g., improving an existing (insufficiently normalized) database design based on the known set of dependencies).

In some implementations, the question answering platform may utilize a data cleansing method to process the documents and the previously answered questions and to detect and/or correct corrupt or inaccurate data from the documents and the previously answered questions. The data cleansing method may include detecting and correcting (or removing) corrupt or inaccurate data (e.g., records from a record set, table, or database), and then replacing, modifying, or deleting the corrupt or inaccurate data. The data cleansing method may detect and correct inconsistencies originally caused by user entry errors, by corruption in transmission or storage, or by utilization of different definitions for similar data in different data stores. The data cleansing method may include removing typographical errors or validating and correcting values against a known list of entities. In this case, validation may be strict (e.g., rejecting any address that does not have a valid postal code) or fuzzy (e.g., correcting records that partially match existing, known records). The data cleansing method may also include cleaning data by cross checking the data with a validated data set, standardizing the data by changing a reference data set to a new standard (e.g., use of standard codes), and/or the like. Additionally, the data cleansing method may include data enhancement, where data is made more complete by adding related information (e.g., appending an address with any phone number related to that address). The data cleansing method may also involve activities, such as harmonization of data (e.g., harmonization of short codes (e.g., St., Rd., and/or the like) to actual words (e.g., street, road, and/or the like).

As shown in FIG. 1C, and by reference numbers 105 and 120, the question answering platform may process the question for the restricted domain to generate a processed question. In some implementations, the question answering platform may utilize a variety of processing techniques to process the question and generate additional information that aids in interpreting the question. In such implementations, the additional information and the question may be referred to as the processed question. In some implementations, the processing techniques may include a part-of-speech (POS) tagging technique, a named entity tagging technique, and/or the like.

In corpus linguistics, a POS tagging technique (e.g., also referred to as grammatical tagging or word-category disambiguation) may include marking a word in a text (e.g., corpus) as corresponding to a particular part of speech, based on both a definition and a context of the word (e.g., a relationship of the word with adjacent and related words in a phrase, a sentence, a paragraph, and/or the like). The POS tagging technique may associate discrete terms, as well as hidden parts of speech, in accordance with a set of descriptive tags. The POS tagging technique may include a rule-based technique, a stochastic technique, and/or the like.

The named entity tagging technique (e.g., also known as named entity recognition, entity identification, entity chunking, entity extraction, and/or the like) may locate and classify named entities in text into pre-defined categories, such as the names of persons, organizations, locations, expressions of times, quantities, monetary values, percentages, and/or the like. In some implementations, the named entity tagging technique may process an unannotated block of text (e.g., “Jim bought 300 shares of Acme Corp. in 2006”) to generate an annotated block of text that highlights names of entities (e.g., “[Jim]_{Person} bought 300 shares of [Acme Corp.]_{Organization} in [2006]_{Time}”). In the example provided in parentheses, the named entity technique may detect and classify a single token person name, a two-token company name, and a temporal expression.

As shown in FIG. 1D, and by reference number 125, the question answering platform may process the processed question, with a machine learning model, to classify the question as a factoid question type or a descriptive question type. In some implementations, the factoid question type may include a question with an answer that includes an entity or a phrase. For example, the factoid question type may include a question, such as “What is a best practice that is applied in all testing-related work?” In some implementations, the descriptive question type may include a question with an answer that includes two or more sentences or a short paragraph. For example, the descriptive question type may include a question, such as “What is the software development process?”

In some implementations, the machine learning model may include a Stanford classifier model. The Stanford classifier model may include a general purpose classifier that takes a set of input data and assigns each input data point to one of a set of classes. The Stanford classifier model may generate, from each input data point, features that are associated with positive or negative numeric votes (e.g., weights) for each class. The weights may be learned automatically based on classification training data (e.g., via supervised learning). The Stanford classifier model may work with scaled, real-valued, and categorical inputs, and may support several machine learning models. The Stanford classifier model may support several forms of regularization, which may be needed when building models with very large numbers of predictive features.

As further shown in FIG. 1D, and by reference number 130, the question answering platform may process the processed question, with a rule-based classifier model, to classify the question as a list question type. In some implementations, the list question type may include a question with an answer that includes a list of entities, a list of sentences, and/or the like. For example, the list question type may include a question, such as “What are the factors to be considered when determining the complexity of a performance test script?”

In some implementations, the rule-based classifier model may include a model that classifies a question based on one or more rules. In some implementations, the one or more rules may include a rule that classifies a question that starts with “please give me the list of” as a list question type, a rule that classifies a question that starts with “mention the list of” as a list question type, a rule that classifies a question that starts with “what kind of” as a list question type, a rule that classifies a question that starts with “provide the list of” as a list question type, a rule that classifies a question that starts with “list the name of” as a list question type, a rule that classifies a question that does not start with any of the aforementioned phrases as not a list question type, and/or the like.

In some implementations, the question answering platform may classify questions to identify a strategy for extracting candidate answers. For example, a strategy for a factoid question type may include utilizing a template filling approach, a strategy for a list question type may include utilizing subsequent bulleted or comma-separated sections in a text fragment designated as a potential candidate answer, and/or the like.

As shown in FIG. 1E, and by reference numbers 105, 135, and 140, the question answering platform may manipulate the question for the restricted domain to generate a query from the question. In some implementations, the question answering platform may manipulate the question to generate a query that may be utilized to search the corpus of searchable information described above in connection with FIG. 1B. In some implementations, the question answering platform may utilize one or more processing techniques to manipulate the question and generate the query. For example, in order the generate the query, the question answering platform may remove one or more stop words and one or more punctuation symbols from the question, may concatenate one or more nouns, verbs, adjectives, and/or the like, in a same order in which such words appear in the question, and/or the like.

As shown in FIG. 1F, and by reference numbers 140, 145, and 150, the question answering platform may process the query, with one or more expansion techniques, to generate an expanded query. In some implementations, the question answering platform may reformulate the query to generate the expanded query so that a retrieval performance of the expanded query (e.g., from the corpus of searchable information described above in connection with FIG. 1B) is greater than a retrieval performance of the query (e.g., from the corpus of searchable information). In some implementations, the one or more expansion techniques may include a technique that utilizes a thesaurus, a technique that utilizes pseudo-relevance feedback, a technique that utilizes a distributional representation, and/or the like.

In some implementations, the technique that utilizes a thesaurus may utilize a particular thesaurus (e.g., a lexical database, for a particular language, that groups words into sets of synonyms, WordNet, and/or the like) to expand the query into the expanded query (e.g., by adding synonyms for words in the query).

In some implementations, the technique that utilizes pseudo-relevance feedback may utilize the query with an index of documents to retrieve a set of documents, and may filter the set of documents to particular documents that are the top-ranked documents in the set of documents. The technique that utilizes pseudo-relevance feedback may consider the particular documents to be relevant, may extract terms from the particular documents, and may add the terms to the query to generate the expanded query.

In some implementations, the technique that utilizes a distributional representation may create the expanded query by using distributed representations of the query. In some implementations, an effectiveness of the technique may depend on not having outliers in the distributed representations. In order to prevent outliers, the technique may utilize an adaptive strategy to select an initial candidate, as follows:

$${W}_{closest} = {argmax}_{W ∈ E} \{ cosine ( {W}_{q} , W ) \} ,$$

where W_{q} may represent a query word and W may represent a word from a word embedding table (E). The technique may calculate a set of neighborhood words, N(W_{q}), for a query word W_{q}, as follows:

N(W_{q})={W|cosine(W_{q},W)≤(1+σ)×cosine(W_{q},W_{closest})},

where σ may represent an empirical parameter, and cosine (Wq, W) may represent a cosine similarity between a word vector of W_{q} and W. The technique may add the set of neighborhood words of the query in order to produce the expanded query.

In some implementations, the question answering platform may utilize a taxonomy (e.g., an ontology) to generate the corpus of searchable information and/or to generate the expanded query. In such implementations, the taxonomy may be created by domain experts, trained by third party ontology applications, and/or the like.

As shown in FIG. 1G, and by reference numbers 150, 155, and 160, the question answering platform may utilize the expanded query, with the corpus of searchable information described above in connection with FIG. 1B, to identify candidate answers to the question. In some implementations, the question answering platform may compare terms in the expanded query with the corpus of searchable information, and may identify information (e.g., the candidate answers) that match one or more terms in the expanded query. In some implementations, the question answering platform may store the candidate answers in a memory associated with the question answering platform.

As shown in FIG. 1H, and by reference numbers 125, 130, 160, 165, and 170, the question answering platform may process the candidate answers and the question classification type (e.g., a factoid question type, a descriptive question type, or a list question type), with one or more deep learning models, to generate scored and ranked candidate answers. In some implementations, the one or more deep learning models may include a convolutional neural network (CNN) model, a heuristic model, and/or the like.

In some implementations, the CNN model may receive a question and a candidate answer as inputs, and may generate a score for the candidate answer as an output. In some implementations, the CNN model may include a sentence representation matrix, a convolution layer, a pooling layer, and a fully connected layer. With regard to the sentence representation matrix, a question (Q) and a candidate answer (A) may include quantities (e.g., n_{Q} and n_{A}, respectively) of tokens, where each token tᵢ∈Q may be represented by a distributed representation x∈R^{k}, and each token tⱼ∈A may be represented by a distributed representation y∈R^{k}. The distributed representations x and y may be identified in a word embedding matrix W. The CNN model may generate a question representation matrix by concatenating the distributed representations xᵢ and yᵢ for every ith token in the question Q and the candidate answer A. The question and answer representation matrices (e.g., x_{1:nQ} and y_{1:nA}) may be represented as:

x_{1:nQ}=x₁⊗x₂ . . . ⊗x_{nQ}

y_{1:nA}=y₁⊗y₂ . . . ⊗y_{nA},

where ⊗ may represent a concatenation operator. After this, the CNN model may capture low-level word features, which may be projected at the higher levels.

With regard to the convolution layer, a convolution operator may be applied to the question and answer representation matrices. The convolution operator may include a filter (e.g., F∈R^{m×k}), which may be applied to a window of (m) words and may produce new features (e.g., cᵢ and cⱼ) for the question and answer matrices, respectively. The features cᵢ and cⱼ may be generated from a context window (e.g., x_{i:i+m-1} and x_{j:j+m-1}) for the question and the candidate answer as follows:

cᵢ=f(F·x_{i:i+m-1}+b)

cⱼ=f(F·y_{j:j+m-1}+b)

where f may represent a non-linear function and b may represent a bias term. The filter F may be applied to each possible window around a word in the question and the candidate answer. This may generate a set of features, also called a feature map. A feature map (e.g., c_{Q} and c_{A}) may be generated by applying each possible window around a word, as follows:

c_{Q}=[cᵢ₁,cᵢ₂, . . . ,c_{Qn-h+1}]

c_{A}=[cⱼ₁,cⱼ₂, . . . ,c_{An-h+1}].

The pooling layer may aggregate information and reduce the question and answer representation matrices. The pooling layer may apply a maximum pooling operation over the feature map, and may obtain a maximum value as a feature corresponding to the filter F. The pooling layer may apply the pooling operation on both c_{Q} and c_{A} to generate outputs (e.g., p_{Q} and p_{A}).

The fully connected layer may concatenate the outputs of the pooling layer (e.g., p_{Q} and p_{A}) to generate a resulting pooling layer (e.g., p=p_{Q}⊗p_{A}), and may subject the resulting pooling layer to a fully connected softmax layer (S_{c}), as follows:

$${S}_{c} ( c = l \vert Q , A , p , a ) = {softmax}_{l} ( {p}^{T} w + a ) = \frac{{e}^{{p}^{T} {w}_{l} + {a}_{l}}}{{\sum }_{k = 1}^{K} {e}^{{p}^{T} {w}_{l} + {a}_{l}}} ,$$

Where S_{c} may represent a score for the CNN model, and aₖ and wₖ may represent a bias vector and a weight vector, respectively, of a kth label.

In some implementations, the heuristic model may include one or more techniques for scoring the candidate answers, such a semantic similarity score technique, a document ranking technique, a term coverage score technique, an N-Gram coverage score technique, a longest common substring score technique, and/or the like.

The semantic similarity score (SS) technique may determine a semantic representation of the question (e.g., a word vector VEC(Q)) using word vector averaging, as follows:

$$VEC ( Q ) = \frac{{\sum }_{{t}_{i} ∈ Q} VEC ( {t}_{i} ) \times tf - {idf}_{{t}_{i}}}{number of lookups} ,$$

where q may represent the question, VEC(tᵢ) may represent a word vector of word tᵢ, and number of lookups may represent a number of words in the question for which word embeddings are available. The semantic similarity score technique may determine a word vector (e.g., VEC(A)) for the candidate answer in a similar manner. The semantic similarity score technique may calculate a cosine similarity between the question word vector and the candidate answer word vector as follows:

SS=cosine(VEC(Q),VEC(A)).

The document ranking (DR) technique may include utilizing a document ranking from a particular source (e.g., the corpus of searchable information, extracted text fragments that are potential answers and are retrieved as answers to the expanded query, and/or the like) to score the candidate answer. The term coverage score (TC) technique may include calculating a ratio of a common term between the question and the candidate answer, and utilizing the ratio to score the candidate answer. The N-Gram coverage score (NG) technique may include calculating a ratio of a common N-gram between the question and the candidate answer, and utilizing the ratio to score the candidate answer. The longest common substring score (LCS) technique may include calculating a length of a longest common substring between the question and the candidate answer.

In some implementations, the heuristic model may calculate a final heuristic score (e.g., Sₕ(Q, A)) based on the one or more techniques for scoring the candidate answers, and as follows:

Sₕ(Q,A)=w₁*SS+w₂*DR+w₃*TC+w₄*NG+w₅*LCS,

where wₖ may represent tunable weights, and k∈{1, . . . , 5}.

In some implementations, the question answering platform may determine a final score (e.g., S(Q, A)) for the candidate answer by aggregating the scores obtained by the CNN model and the heuristic model, as follows:

S(Q,A)=W×S_{c}(Q,A)+V×Sₕ(Q,A),

where S_{c}(Q, A) may represent a score obtained by the CNN model, Sₕ(Q, A) may represent a score obtained by the heuristic model, and W and V may represent tunable weights. In some implementations, the question answering platform may rank the candidate answers (e.g., from highest to lowest, from lowest to highest, and/or the like) based on the final scores determined for the candidate answers.

As shown in FIG. 1I, and by reference numbers 170, 175, and 180, the question answering platform may select an answer to the question from the scored and ranked candidate answers. In some implementations, the question answering platform may select the answer from the scored and ranked candidate answers based on the classification type of the question (e.g., a factoid question type, a descriptive question type, or a list question type). In some implementations, the question answering platform may select a highest ranked candidate answer as the answer, may select a top two highest ranked candidate answers as the answer, may select a top five highest ranked candidate answers as the answer, and/or the like. In some implementations where more than one candidate answer is selected, the question answering platform may combine the selected candidate answers into a single answer.

In some implementations, the question answering platform may validate the answer based on the classification type of the question. For example, if the question is a factoid question type, the question answering platform may validate that the answer is a factoid answer type. If the answer is not a factoid answer type, the question answering platform may reject the selected candidate answer and may select another candidate answer that is a factoid answer type.

If the question is a descriptive question type, the question answering platform may determine whether the answer is a short descriptive answer (e.g., two to three sentences long), and may calculate a pattern score between the question and the selected candidate answer. The pattern score may be calculated by analyzing the selected candidate answer, and calculating a confidence score associated with whether the selected candidate answer matches the question. The question answering platform may combine the pattern score (e.g., Sₚ(Q, A)) with the final score for the candidate answer, as follows:

S′^{(Q,A)}=W×S_{c}(Q,A)+V×Sₕ(Q,A)+U×Sₚ(Q,A),

where U may represent a tunable weight. A candidate answer with a maximum score (e.g., S′(Q, A)) may be determined as the answer.

If the question is a list question type, the question answering platform may utilize a strategy to extract sufficient information as the answer for a list question type. For example, the question answering platform may filter candidate paragraphs based on list information and sizes of the candidate paragraphs, and may score each candidate paragraph based on the following equation:

Sₕ(Q,A)=w₁*SS+w₂*DR+w₃*TC+w₄*NG+w₅*LCS.

The question answering platform may select the candidate paragraph with the maximum score, and may extract the sentences from the selected paragraph using sentence segmentation. The question answering platform may score each sentence based on the following equation:

S(Q,A)=W×S_{c}(Q,A)+V×Sₕ(Q,A).

The question answering platform may select sentences having a score greater than a predetermined threshold value, and may utilize the selected sentences to generate the answer to the question.

As shown in FIG. 1J, and by reference number 185, the question answering platform may provide, to the user device, information indicating the answer (e.g., “Satisfy the customer through the early and continuous delivery of valuable software, welcome changing requirements even late in the development, face-to-face conversation, deliver working software frequently, etc.”) to the question (e.g., “Can you list the principles of Agile Testing?”), and the user device may display the information indicating the answer to the user of the user device (e.g., via a user interface).

In this way, several different stages of the process for utilizing deep learning to provide question answering for a restricted domain are automated, which may remove human subjectivity and waste from the process, and which may improve speed and efficiency of the process and conserve computing resources (e.g., processor resources, memory resources, and/or the like). Furthermore, implementations described herein use a rigorous, computerized process to perform tasks or roles that were not previously performed or were previously performed using subjective human intuition or input. For example, current systems are unable to answer questions associated with a restricted domain due to contextual appropriateness, semantically different terminology, and lack of adequate training data. Finally, automating the process for utilizing deep learning to provide question answering for a restricted domain conserves computing resources (e.g., processor resources, memory resources, and/or the like) that would otherwise be wasted in attempting to provide question answering for a restricted domain.

As indicated above, FIGS. 1A-1J are provided merely as examples. Other examples are possible and may differ from what was described with regard to FIGS. 1A-1J. For example, although FIGS. 1A-1J described the question answering platform being used with image-related information, in some implementations, the question answering platform may be utilized with other types of information that may benefit from automating the process for generating a machine learning model for objects based on augmenting the objects with physical properties.

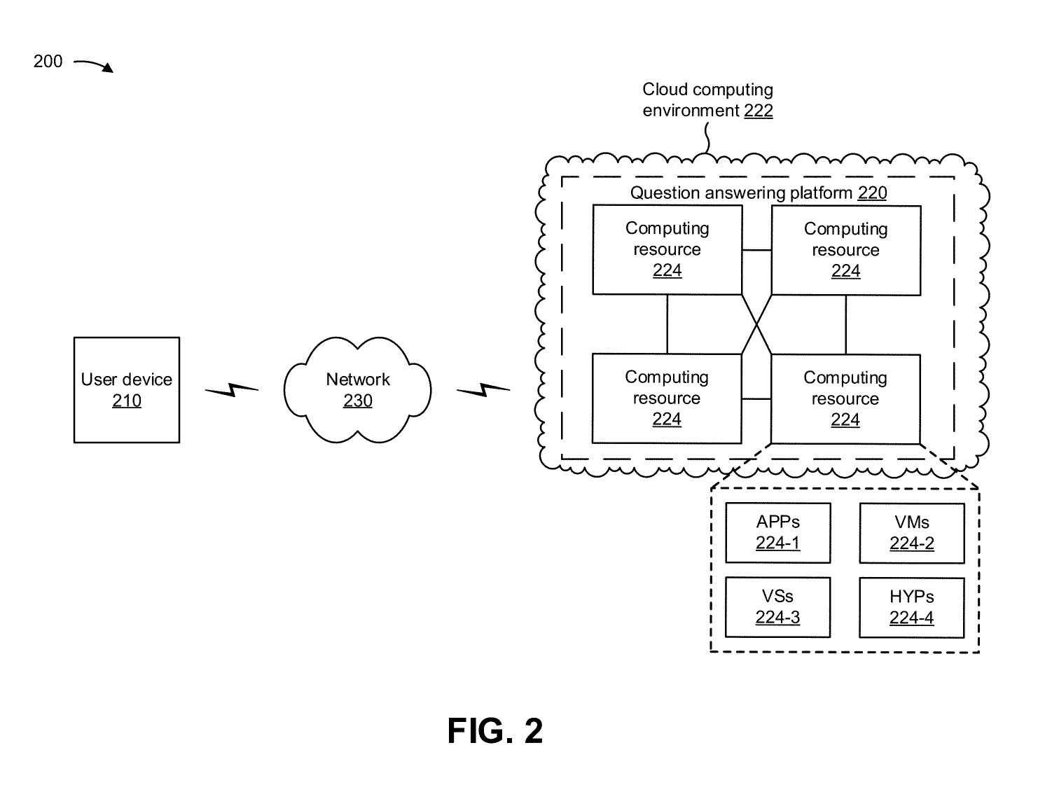

FIG. 2 is a diagram of an example environment 200 in which systems and/or methods, described herein, may be implemented. As shown in FIG. 2, environment 200 may include a user device 210, a question answering platform 220, and a network 230. Devices of environment 200 may interconnect via wired connections, wireless connections, or a combination of wired and wireless connections.

User device 210 includes one or more devices capable of receiving, generating, storing, processing, and/or providing information, such as information described herein. For example, user device 210 may include a mobile phone (e.g., a smart phone, a radiotelephone, etc.), a laptop computer, a tablet computer, a desktop computer, a handheld computer, a gaming device, a wearable communication device (e.g., a smart wristwatch, a pair of smart eyeglasses, etc.), or a similar type of device. In some implementations, user device 210 may receive information from and/or transmit information to question answering platform 220.

Question answering platform 220 includes one or more devices that utilize deep learning to provide question answering for a restricted domain. In some implementations, question answering platform 220 may be designed to be modular such that certain software components may be swapped in or out depending on a particular need. As such, question answering platform 220 may be easily and/or quickly reconfigured for different uses. In some implementations, question answering platform 220 may receive information from and/or transmit information to one or more user devices 210.

In some implementations, as shown, question answering platform 220 may be hosted in a cloud computing environment 222. Notably, while implementations described herein describe question answering platform 220 as being hosted in cloud computing environment 222, in some implementations, question answering platform 220 may not be cloud-based (i.e., may be implemented outside of a cloud computing environment) or may be partially cloud-based.

Cloud computing environment 222 includes an environment that hosts question answering platform 220. Cloud computing environment 222 may provide computation, software, data access, storage, etc. services that do not require end-user knowledge of a physical location and configuration of system(s) and/or device(s) that hosts question answering platform 220. As shown, cloud computing environment 222 may include a group of computing resources 224 (referred to collectively as “computing resources 224” and individually as “computing resource 224”).

Computing resource 224 includes one or more personal computers, workstation computers, server devices, or other types of computation and/or communication devices. In some implementations, computing resource 224 may host question answering platform 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, and/or the like.

Application 224-1 includes one or more software applications that may be provided to or accessed by user device 210. Application 224-1 may eliminate a need to install and execute the software applications on user device 210. For example, application 224-1 may include software associated with question answering platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports execution of a complete operating system (“OS”). A process virtual machine may execute a single program, and may support a single process. In some implementations, virtual machine 224-2 may execute on behalf of a user (e.g., a user of user device 210 or an operator of question answering platform 220), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems, and may manage the execution of the guest operating systems. Multiple instances of a variety of operating systems may share virtualized hardware resources.

Network 230 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

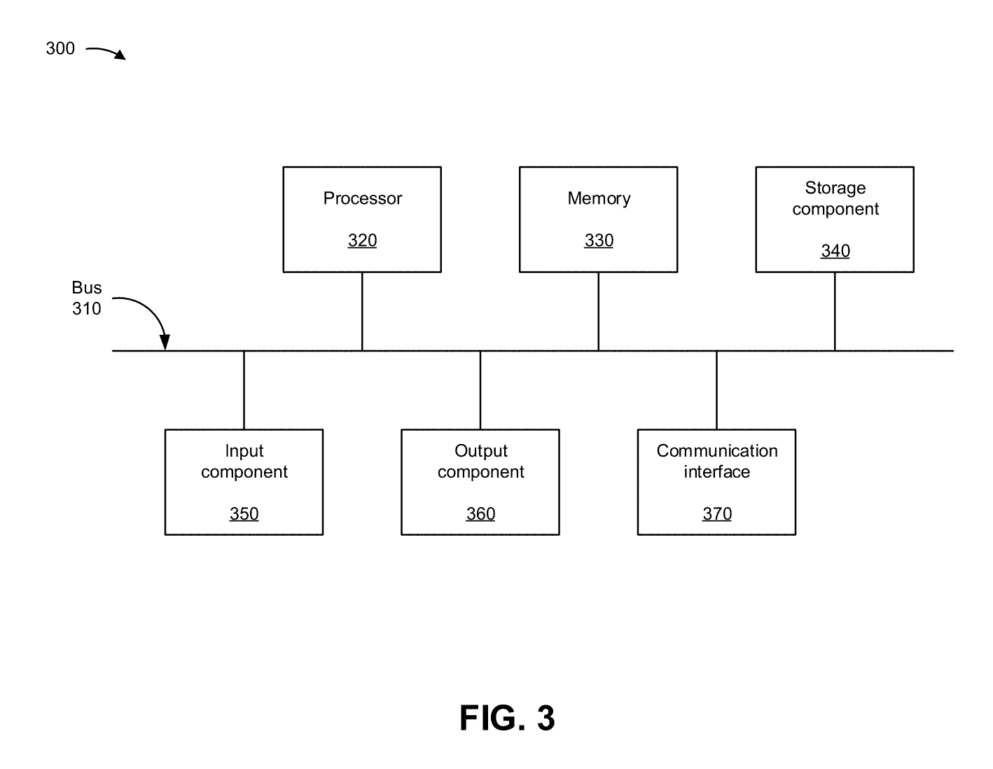

FIG. 3 is a diagram of example components of a device 300. Device 300 may correspond to user device 210, question answering platform 220, and/or computing resource 224. In some implementations, user device 210, question answering platform 220, and/or computing resource 224 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a wireless local area network interface, a cellular network interface, and/or the like.

Device 300 may perform one or more processes described herein. Device 300 may perform these processes based on processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

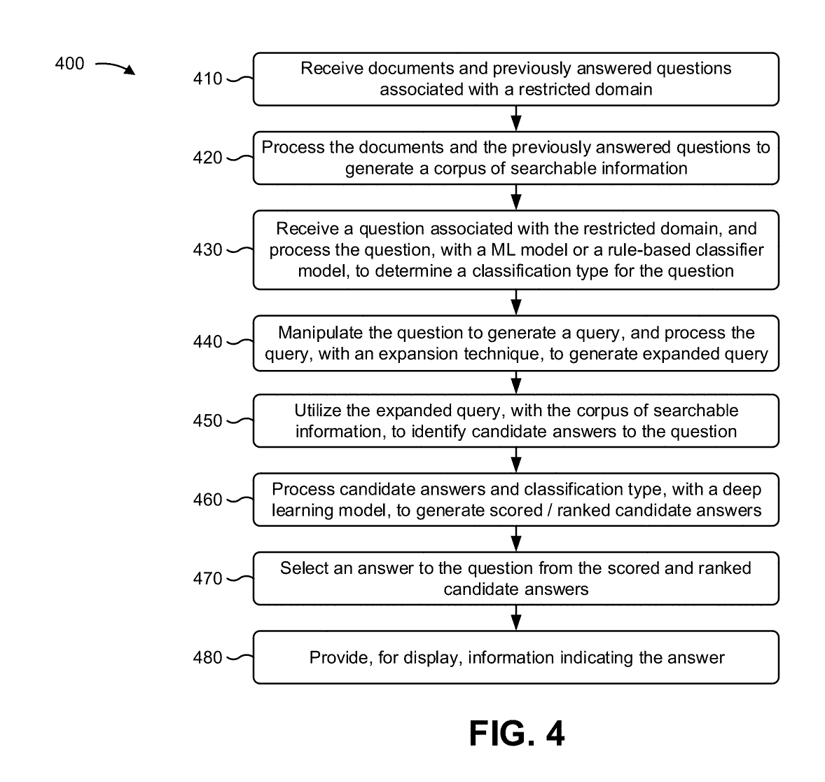

FIG. 4 is a flow chart of an example process 400 for utilizing deep learning to provide question answering for a restricted domain. In some implementations, one or more process blocks of FIG. 4 may be performed by a question answering platform (e.g., question answering platform 220). In some implementations, one or more process blocks of FIG. 4 may be performed by another device or a group of devices separate from or including the question answering platform, such as a user device (e.g., user device 210).

As shown in FIG. 4, process 400 may include receiving documents and previously answered questions associated with a restricted domain (block 410). For example, the question answering platform (e.g., using computing resource 224, processor 320, communication interface 370, and/or the like) may receive documents and previously answered questions associated with a restricted domain, as described above in connection with FIGS. 1A-2.

As further shown in FIG. 4, process 400 may include processing the documents and the previously answered questions to generate a corpus of searchable information (block 420). For example, the question answering platform (e.g., using computing resource 224, processor 320, memory 330, and/or the like) may process the documents and the previously answered questions to generate a corpus of searchable information, as described above in connection with FIGS. 1A-2.

As further shown in FIG. 4, process 400 may include receiving a question associated with the restricted domain, and processing the question, with a machine learning model or a rule-based classifier model, to determine a classification type for the question (block 430). For example, the question answering platform (e.g., using computing resource 224, processor 320, storage component 340, communication interface 370, and/or the like) may receive a question associated with the restricted domain, and may process the question, with a machine learning model or a rule-based classifier model, to determine a classification type for the question, as described above in connection with FIGS. 1A-2.

As further shown in FIG. 4, process 400 may include manipulating the question to generate a query from the question, and processing the query, with an expansion technique, to generate an expanded query (block 440). For example, the question answering platform (e.g., using computing resource 224, processor 320, memory 330, and/or the like) may manipulate the question to generate a query from the question, and may process the query, with an expansion technique, to generate an expanded query, as described above in connection with FIGS. 1A-2.

As further shown in FIG. 4, process 400 may include utilizing the expanded query, with the corpus of searchable information, to identify candidate answers to the question (block 450). For example, the question answering platform (e.g., using computing resource 224, processor 320, storage component 340, and/or the like) may utilize the expanded query, with the corpus of searchable information, to identify candidate answers to the question, as described above in connection with FIGS. 1A-2.

As further shown in FIG. 4, process 400 may include processing the candidate answers and the classification type for the question, with a deep learning model, to generate scored and ranked candidate answers to the question (block 460). For example, the question answering platform (e.g., using computing resource 224, processor 320, memory 330, and/or the like) may process the candidate answers and the classification type for the question, with a deep learning model, to generate scored and ranked candidate answers to the question, as described above in connection with FIGS. 1A-2.

As further shown in FIG. 4, process 400 may include selecting an answer to the question from the scored and ranked candidate answers (block 470). For example, the question answering platform (e.g., using computing resource 224, processor 320, storage component 340, and/or the like) may select an answer to the question from the scored and ranked candidate answers, as described above in connection with FIGS. 1A-2.

As further shown in FIG. 4, process 400 may include providing, for display, information indicating the answer (block 480). For example, the question answering platform (e.g., using computing resource 224, processor 320, communication interface 370, and/or the like) may provide, for display, information indicating the answer, as described above in connection with FIGS. 1A-2.

Process 400 may include additional implementations, such as any single implementation or any combination of implementations described below and/or described with regard to any other process described herein.

In some implementations, the classification type for the question may include a factoid question type, a descriptive question type, a list question type, and/or the like. In some implementations, the expansion technique may include a technique that utilizes a thesaurus, a technique that utilizes pseudo-relevance feedback, a technique that utilizes a distributional representation, and/or the like.

In some implementations, the question answering platform may process the candidate answers and the classification type for the question, with a convolutional neural network (CNN) model and a heuristic model, to generate the scored and ranked candidate answers to the question. In some implementations, the CNN model may include a sentence representation matrix, a convolution layer, a pooling layer, a fully connected layer, and/or the like. In some implementations, the heuristic model may utilize a semantic similarity score technique, a document ranking technique, a term coverage score technique, an N-Gram coverage score technique, a longest common substring score technique, and/or the like.

In some implementations, the question answering platform may select a factoid type answer as the answer when the classification type for the question is a factoid question type, may calculate pattern scores between the scored and ranked candidate answers and the question and select the answer based on the pattern scores, when the classification type for the question is a descriptive question type, and/or may calculate scores for one or more paragraphs and one or more sentences in the one or more paragraphs of the answer, and select a sentence, of the one or more sentences, as the answer based on the scores for the one or more paragraphs and the one or more sentences, when the classification type for the question is a list question type.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

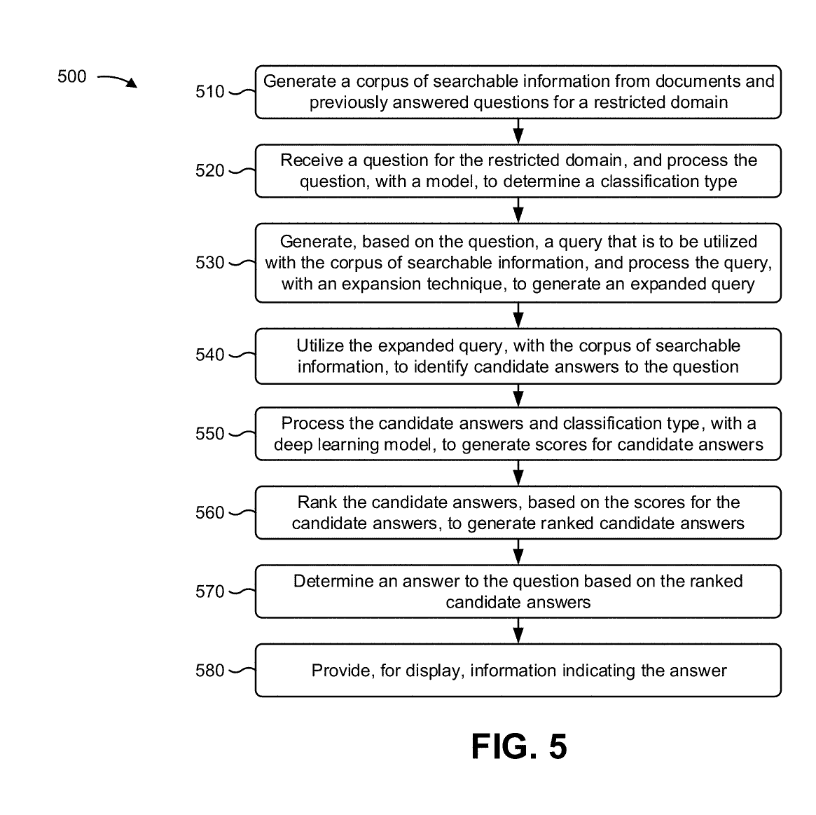

FIG. 5 is a flow chart of an example process 500 for utilizing deep learning to provide question answering for a restricted domain. In some implementations, one or more process blocks of FIG. 5 may be performed by a question answering platform (e.g., question answering platform 220). In some implementations, one or more process blocks of FIG. 5 may be performed by another device or a group of devices separate from or including the question answering platform, such as a user device (e.g., user device 210).

As shown in FIG. 5, process 500 may include generating a corpus of searchable information from documents and previously answered questions associated with a restricted domain (block 510). For example, the question answering platform (e.g., using computing resource 224, processor 320, memory 330, communication interface 370, and/or the like) may generate a corpus of searchable information from documents and previously answered questions associated with a restricted domain, as described above in connection with FIGS. 1A-2.

As further shown in FIG. 5, process 500 may include receiving a question associated with the restricted domain, and processing the question, with a model, to determine a classification type for the question (block 520). For example, the question answering platform (e.g., using computing resource 224, processor 320, memory 330, communication interface 370, and/or the like) may receive a question associated with the restricted domain, and may process the question, with a model, to determine a classification type for the question, as described above in connection with FIGS. 1A-2.

As further shown in FIG. 5, process 500 may include generating, based on the question, a query that is to be utilized with the corpus of searchable information, and processing the query, with an expansion technique, to generate an expanded query (block 530). For example, the question answering platform (e.g., using computing resource 224, processor 320, storage component 340, communication interface 370, and/or the like) may generate, based on the question, a query that is to be utilized with the corpus of searchable information, and may process the query, with an expansion technique, to generate an expanded query, as described above in connection with FIGS. 1A-2.

As further shown in FIG. 5, process 500 may include utilizing the expanded query, with the corpus of searchable information, to identify candidate answers to the question (block 540). For example, the question answering platform (e.g., using computing resource 224, processor 320, memory 330, and/or the like) may utilize the expanded query, with the corpus of searchable information, to identify candidate answers to the question, as described above in connection with FIGS. 1A-2.

As further shown in FIG. 5, process 500 may include processing the candidate answers and the classification type for the question, with a deep learning model, to generate scores for the candidate answers to the question (block 550). For example, the question answering platform (e.g., using computing resource 224, processor 320, storage component 340, and/or the like) may process the candidate answers and the classification type for the question, with a deep learning model, to generate scores for the candidate answers to the question, as described above in connection with FIGS. 1A-2.

As further shown in FIG. 5, process 500 may include ranking the candidate answers, based on the scores for the candidate answers, to generate ranked candidate answers (block 560). For example, the question answering platform (e.g., using computing resource 224, processor 320, memory 330, and/or the like) may rank the candidate answers, based on the scores for the candidate answers, to generate ranked candidate answers, as described above in connection with FIGS. 1A-2.

As further shown in FIG. 5, process 500 may include determining an answer to the question based on the ranked candidate answers (block 570). For example, the question answering platform (e.g., using computing resource 224, processor 320, storage component 340, and/or the like) may determine an answer to the question based on the ranked candidate answers, as described above in connection with FIGS. 1A-2.

As further shown in FIG. 5, process 500 may include providing, for display, information indicating the answer (block 580). For example, the question answering platform (e.g., using computing resource 224, processor 320, communication interface 370, and/or the like) may provide, for display, information indicating the answer, as described above in connection with FIGS. 1A-2.

Process 500 may include additional implementations, such as any single implementation or any combination of implementations described below and/or described with regard to any other process described herein.

In some implementations, the question answering platform may receive the documents and the previously answered questions associated with the restricted domain, and may process the documents and the previously answered questions to generate the corpus of searchable information. In some implementations, the classification type for the question may include a factoid question type, a descriptive question type, a list question type, and/or the like. In some implementations, the expansion technique may include a technique that utilizes a thesaurus, a technique that utilizes pseudo-relevance feedback, a technique that utilizes a distributional representation, and/or the like.

In some implementations, the question answering platform may determine a factoid type answer as the answer when the classification type for the question is a factoid question type, may calculate pattern scores between the ranked candidate answers and the question and determine the answer based on the pattern scores, when the classification type for the question is a descriptive question type, and/or may calculate scores for one or more paragraphs and one or more sentences in the one or more paragraphs of the answer, and determine a sentence, of the one or more sentences, as the answer based on the scores for the one or more paragraphs and the one or more sentences, when the classification type for the question is a list question type.

In some implementations, the deep learning model may include a convolutional neural network (CNN) model that includes a sentence representation matrix, a convolution layer, a pooling layer, a fully connected layer, and/or the like, and/or may include a heuristic model that utilizes a semantic similarity score technique, a document ranking technique, a term coverage score technique, an N-Gram coverage score technique, a longest common substring score technique, and/or the like. In some implementations, the question answering platform may validate the answer based on the classification type for the question and prior to providing the information indicating the answer.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

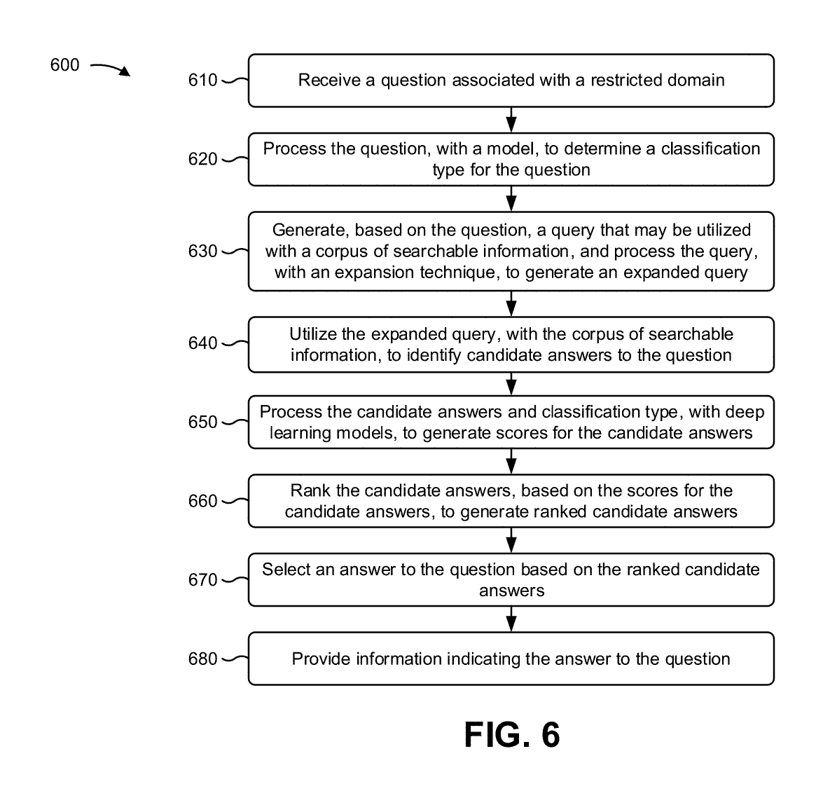

FIG. 6 is a flow chart of an example process 600 for utilizing deep learning to provide question answering for a restricted domain. In some implementations, one or more process blocks of FIG. 6 may be performed by a question answering platform (e.g., question answering platform 220). In some implementations, one or more process blocks of FIG. 6 may be performed by another device or a group of devices separate from or including the question answering platform, such as a user device (e.g., user device 210).

As shown in FIG. 6, process 600 may include receiving, from a user device, a question associated with a restricted domain (block 610). For example, the question answering platform (e.g., using computing resource 224, processor 320, communication interface 370, and/or the like) may receive, from a user device, a question associated with a restricted domain, as described above in connection with FIGS. 1A-2.

As further shown in FIG. 6, process 600 may include processing the question, with a model, to determine a classification type for the question (block 620). For example, the question answering platform (e.g., using computing resource 224, processor 320, memory 330, and/or the like) may process the question, with a model, to determine a classification type for the question, as described above in connection with FIGS. 1A-2.

As further shown in FIG. 6, process 600 may include generating, based on the question, a query that is capable of being utilized with a corpus of searchable information, and processing the query, with an expansion technique, to generate an expanded query (block 630). For example, the question answering platform (e.g., using computing resource 224, processor 320, storage component 340, and/or the like) may generate, based on the question, a query that is capable of being utilized with a corpus of searchable information, and may process the query, with an expansion technique, to generate an expanded query, as described above in connection with FIGS. 1A-2.

As further shown in FIG. 6, process 600 may include utilizing the expanded query, with the corpus of searchable information, to identify candidate answers to the question (block 640). For example, the question answering platform (e.g., using computing resource 224, processor 320, memory 330, communication interface 370, and/or the like) may utilize the expanded query, with the corpus of searchable information, to identify candidate answers to the question, as described above in connection with FIGS. 1A-2.

As further shown in FIG. 6, process 600 may include processing the candidate answers and the classification type for the question, with one or more deep learning models, to generate scores for the candidate answers to the question (block 650). For example, the question answering platform (e.g., using computing resource 224, processor 320, memory 330, and/or the like) may process the candidate answers and the classification type for the question, with one or more deep learning models, to generate scores for the candidate answers to the question, as described above in connection with FIGS. 1A-2.

As further shown in FIG. 6, process 600 may include ranking the candidate answers, based on the scores for the candidate answers, to generate ranked candidate answers (block 660). For example, the question answering platform (e.g., using computing resource 224, processor 320, storage component 340, and/or the like) may rank the candidate answers, based on the scores for the candidate answers, to generate ranked candidate answers, as described above in connection with FIGS. 1A-2.

As further shown in FIG. 6, process 600 may include selecting an answer to the question based on the ranked candidate answers (block 670). For example, the question answering platform (e.g., using computing resource 224, processor 320, memory 330, and/or the like) may select an answer to the question based on the ranked candidate answers, as described above in connection with FIGS. 1A-2.

As further shown in FIG. 6, process 600 may include providing, to the user device, information indicating the answer to the question (block 680). For example, the question answering platform (e.g., using computing resource 224, processor 320, communication interface 370, and/or the like) may provide, to the user device, information indicating the answer to the question, as described above in connection with FIGS. 1A-2.

Process 600 may include additional implementations, such as any single implementation or any combination of implementations described below and/or described with regard to any other process described herein.

In some implementations, the question answering platform may receive documents and previously answered questions associated with the restricted domain, and may process the documents and the previously answered questions to generate the corpus of searchable information. In some implementations, the question answering platform may select a factoid type answer as the answer when the classification type for the question is a factoid question type, may calculate pattern scores between the ranked candidate answers and the question and select the answer based on the pattern scores, when the classification type for the question is a descriptive question type, and/or may calculate scores for one or more paragraphs and one or more sentences in the one or more paragraphs of the answer, and select a sentence, of the one or more sentences, as the answer based on the scores for the one or more paragraphs and the one or more sentences, when the classification type for the question is a list question type.

In some implementations, the question answering platform may process the candidate answers and the classification type for the question, with a convolutional neural network (CNN) model and a heuristic model, to generate the scores for the candidate answers to the question. In some implementations, the expansion technique may include a technique that utilizes a thesaurus, a technique that utilizes pseudo-relevance feedback, a technique that utilizes a distributional representation, and/or the like. In some implementations, the question answering platform may validate the answer based on the classification type for the question and prior to providing the information indicating the answer.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

Some implementations described herein utilize deep learning to provide question answering for a restricted domain. For example, a question answering platform may receive documents and previously answered questions associated with a restricted domain, and may process the documents and the previously answered questions to generate a corpus of searchable information. The question answering platform may receive a question associated with the restricted domain, and may process the question, with a machine learning model or a rule-based classifier model, to determine a classification type for the question. The question answering platform may manipulate the question to generate a query from the question, and may process the query, with an expansion technique, to generate an expanded query. The question answering platform may utilize the expanded query, with the corpus of searchable information, to identify candidate answers to the question, and may process the candidate answers and the classification type for the question, with a deep learning model, to generate scored and ranked candidate answers to the question. The question answering platform may select an answer to the question from the scored and ranked candidate answers, and may provide, for display, information indicating the answer.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Certain user interfaces have been described herein and/or shown in the figures. A user interface may include a graphical user interface, a non-graphical user interface, a text-based user interface, or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more memories; and
one or more processors, communicatively coupled to the one or more memories, to:
receive documents and previously answered questions associated with a restricted domain;
process the documents and the previously answered questions to generate a corpus of searchable information;
receive a question associated with the restricted domain;
process the question, with a machine learning model or a rule-based classifier model, to determine a classification type for the question;
manipulate the question to generate a query from the question;
process the query, with an expansion technique, to generate an expanded query;
utilize the expanded query, with the corpus of searchable information, to identify candidate answers to the question;
process the candidate answers and the classification type for the question, with a deep learning model, to generate scored and ranked candidate answers to the question;
select an answer to the question from the scored and ranked candidate answers; and
provide, for display, information indicating the answer.

2. The device of claim 1, wherein the classification type for the question includes one of:
a factoid question type,
a descriptive question type, or
a list question type.

3. The device of claim 1, wherein the expansion technique includes one or more of:
a technique that utilizes a thesaurus,
a technique that utilizes pseudo-relevance feedback, or
a technique that utilizes a distributional representation.

4. The device of claim 1, wherein the one or more processors, when processing the candidate answers and the classification type for the question, are to:
process the candidate answers and the classification type for the question, with a convolutional neural network (CNN) model and a heuristic model, to generate the scored and ranked candidate answers to the question.

5. The device of claim 4, wherein the CNN model includes:
a sentence representation matrix,
a convolution layer,
a pooling layer, and
a fully connected layer.

6. The device of claim 4, wherein the heuristic model utilizes one or more of:
a semantic similarity score technique,
a document ranking technique,
a term coverage score technique,
an N-Gram coverage score technique, or
a longest common substring score technique.

7. The device of claim 1, wherein the one or more processors, when selecting the answer, are to one of:
select a factoid type answer as the answer when the classification type for the question is a factoid question type;
calculate pattern scores between the scored and ranked candidate answers and the question and select the answer based on the pattern scores, when the classification type for the question is a descriptive question type; or
calculate scores for one or more paragraphs and one or more sentences in the one or more paragraphs of the answer, and select a sentence, of the one or more sentences, as the answer based on the scores for the one or more paragraphs and the one or more sentences, when the classification type for the question is a list question type.

8. A non-transitory computer-readable medium storing instructions, the instructions comprising:
one or more instructions that, when executed by one or more processors, cause the one or more processors to:
generate a corpus of searchable information from documents and previously answered questions associated with a restricted domain;
receive a question associated with the restricted domain;
process the question, with a model, to determine a classification type for the question;
generate, based on the question, a query that is capable of being utilized with the corpus of searchable information;
process the query, with an expansion technique, to generate an expanded query,
the expanded query including a greater retrieval performance than a retrieval performance of the query;
utilize the expanded query, with the corpus of searchable information, to identify candidate answers to the question;
process the candidate answers and the classification type for the question, with a deep learning model, to generate scores for the candidate answers to the question;
rank the candidate answers, based on the scores for the candidate answers, to generate ranked candidate answers;
determine an answer to the question based on the ranked candidate answers; and
provide, for display, information indicating the answer.

9. The non-transitory computer-readable medium of claim 8, wherein the instructions further comprise:
one or more instructions that, when executed by the one or more processors, cause the one or more processors to:
receive the documents and the previously answered questions associated with the restricted domain; and
process the documents and the previously answered questions to generate the corpus of searchable information.

10. The non-transitory computer-readable medium of claim 8, wherein the classification type for the question includes one of:
a factoid question type,
a descriptive question type, or
a list question type.

11. The non-transitory computer-readable medium of claim 8, wherein the expansion technique includes one or more of:
a technique that utilizes a thesaurus,
a technique that utilizes pseudo-relevance feedback, or
a technique that utilizes a distributional representation.

12. The non-transitory computer-readable medium of claim 8, wherein the one or more instructions, that cause the one or more processors to determine the answer, include:
one or more instructions that, when executed by the one or more processors, cause the one or more processors to one of:
determine a factoid type answer as the answer when the classification type for the question is a factoid question type;
calculate pattern scores between the ranked candidate answers and the question and determine the answer based on the pattern scores, when the classification type for the question is a descriptive question type; or
calculate scores for one or more paragraphs and one or more sentences in the one or more paragraphs of the answer, and determine a sentence, of the one or more sentences, as the answer based on the scores for the one or more paragraphs and the one or more sentences, when the classification type for the question is a list question type.

13. The non-transitory computer-readable medium of claim 8, wherein the deep learning model includes one or more of:
a convolutional neural network (CNN) model that includes:
a sentence representation matrix,
a convolution layer,
a pooling layer, and
a fully connected layer; or
a heuristic model that utilizes one or more of:
a semantic similarity score technique,
a document ranking technique,
a term coverage score technique,
an N-Gram coverage score technique, or
a longest common substring score technique.

14. The non-transitory computer-readable medium of claim 8, wherein the instructions further comprise:
one or more instructions that, when executed by the one or more processors, cause the one or more processors to:
validate the answer based on the classification type for the question and prior to providing the information indicating the answer.

15. A method, comprising:
receiving, by a device and from a user device, a question associated with a restricted domain;
processing, by the device, the question, with a model, to determine a classification type for the question;
generating, by the device and based on the question, a query that is capable of being utilized with a corpus of searchable information;
processing, by the device, the query, with an expansion technique, to generate an expanded query;
utilizing, by the device, the expanded query, with the corpus of searchable information, to identify candidate answers to the question;
processing, by the device, the candidate answers and the classification type for the question, with one or more deep learning models, to generate scores for the candidate answers to the question;
ranking, by the device, the candidate answers, based on the scores for the candidate answers, to generate ranked candidate answers;
selecting, by the device, an answer to the question based on the ranked candidate answers; and
providing, by the device and to the user device, information indicating the answer to the question.

16. The method of claim 15, further comprising:
receiving documents and previously answered questions associated with the restricted domain; and
processing the documents and the previously answered questions to generate the corpus of searchable information.

17. The method of claim 15, wherein selecting the answer to the question comprises one of:
selecting a factoid type answer as the answer when the classification type for the question is a factoid question type;
calculating pattern scores between the ranked candidate answers and the question and selecting the answer based on the pattern scores, when the classification type for the question is a descriptive question type; or
calculating scores for one or more paragraphs and one or more sentences in the one or more paragraphs of the answer, and selecting a sentence, of the one or more sentences, as the answer based on the scores for the one or more paragraphs and the one or more sentences, when the classification type for the question is a list question type.

18. The method of claim 15, wherein processing the candidate answers and the classification type for the question comprises:
processing the candidate answers and the classification type for the question, with a convolutional neural network (CNN) model and a heuristic model, to generate the scores for the candidate answers to the question.

19. The method of claim 15, wherein the expansion technique includes one or more of:
a technique that utilizes a thesaurus,
a technique that utilizes pseudo-relevance feedback, or
a technique that utilizes a distributional representation.

20. The method of claim 15, further comprising:
validating the answer based on the classification type for the question and prior to providing the information indicating the answer.
